(19) United States
(12) Patent Application Publication
(10) Pub. No.: US 2005/0210572 A1
(43) Pub. Date: Sep. 29, 2005

(54) Portable bidet

(76) Inventor: Jeffrey B. Fogel, Long Beach, NY (US)

Correspondence Address: DILWORTH & BARRESE, LLP, 333 EARLE OVINGTON BLVD., UNIONDALE, NY, 11553, US

(21) Appl. No.: 10/808,755

(22) Filed: Mar. 25, 2004

(51) Int. Cl. A47K 3/26; A61H 35/00

(52) U.S. Cl. 4/443

(57) ABSTRACT

A portable bidet configured having a convertible structure with a larger overall size during its use and a compact, smaller size during storing.

### BACKGROUND OF THE INVENTION

1. Field of the Invention

The present invention relates generally to an apparatus for cleansing body parts, and more particularly to a portable bidet configured to conveniently spray cleansing and rinsing fluids onto appropriate and discrete body surfaces.

2. Description of the Related Art

The nature of the human excretory process presents a fundamental situation associated with cleansing the body surface of waste material. While many humans resort to the use of toilet tissue to deal with the situation, such practice can be abrasive, especially for hemorrhoid suffers or for persons preparing for a colonoscopy. Further, physically impaired persons may have difficulty utilizing toilet tissue for this purpose without substantial assistance from another individual. Many individuals who are able to perform the cleansing function with toilet tissue may also prefer not to for reasons such as personal hygiene, personal preference, recovery from an episiotomy or other medical procedure.

Therefore, even for a fully capacitated individual, as the natural excretory process are usually performed while seated on a toilet, cleansing of an individual's crotch area is a desirable function, particularly after the individual has utilized the toilet for defecation. Beyond the use of toilet tissue for achieving this function, the prior art has utilized a variety of apparatuses.

For an incapacitated individual such as a paraplegic or quadriplegic, the cleansing of private body parts may be difficult if not impossible. Such incapacitation is not confined to specific age groups and, thus, even a person in the prime of his life may require assistance from another person to accomplish these simple but extremely private functions. As a result, emotional and psychological struggles are commonly encountered by such incapacitated persons. These containments, cleansing and flushing tasks are extremely personal and can be embarrassing, to say the least, to persons reliant upon others to perform such tasks.

An alternative to toilet tissue is to spray liquid onto body parts of a toilet user, such done via use of a bidet. Bidets, however, are configured as stationary devices. Such devices typically have a fixed nozzle, which leaves the user with no or limited control over the application of cleansing water which given sufficient pressure can spray out onto the user's legs. Some devices provide a nozzle located below the seat that requires reaching down into the bowl to adjust the spray.

Typically, stationary, i.e. non-portable, bidets can be elaborately configured and prone to malfunction. In addition, multiple parts including nozzle heads, the component that delivers fluid to the desired body parts, are often subject to mildew and mold, which readily grow in the moist environment. Furthermore, one of the reasons often voiced against the use of the stationary bidet is that such a bidet occupies the extra space and is cost-prohibitive. Accordingly, few bathrooms are equipped with a bidet.

The need for a relatively simple, cost-sensitive bidet has led to numerous types of self-contained hand-held bidets, such as U.S. Pat. No. 4,890,340 to Lovitt. As convenient as the hand-held bidet has proven to be, typically this type may be found difficult to use due to its relatively large size. Further, such hand-held bidets are stationary and must be connected to existing plumbing systems, which may be inconvenient because of time-consuming mechanical operations. Further, such bidets, like toilets, are typically provided only with a supply of cold water, requiring sophisticated plumbing to achieve a spray of suitable temperature. Overall, hand-held bidets are cumbersome, difficult to store out of sight and many require an obtrusive reservoir tank for attachment. Accordingly, hand-held bidets thus far have remained relatively unpopular.

Thus, an object of the present invention is to provide a portable bidet characterized by a simple, easily maintained structure capable of applying warm, or other desired temperature, water to the desired body parts of the user.

A further object of the invention is to provide a portable bidet with a safe and sanitary nozzle for applying body treatments, and can allow cleansing liquid to achieve room temperature prior to spray application.

Another object of the invention is to provide a portable bidet having greater accessibility to the general population due to its relatively small size and cost-efficiency.

A still further object of invention is to provide a portable bidet having a structure convenient in use without appearing obtrusive, which the user can discretely carry into and use in any available toilet.

### SUMMARY OF THE INVENTION

The inventive portable bidet having a structure easily convertible between an operative ready-to-use and storage position accomplishes the above and other objects of the present invention. According to the invention, the portable bidet is configured with a reservoir made from reinforced resilient material and has a mechanism that facilitates its use when inverted, i.e. turned to an upside-down position.

In accordance with one aspect of the invention, the portable bidet has a unique, two-sided screw-top traversed by a hollow tube and capable of closing the reservoir with a larger portion of the hollow tube extending within the reservoir in a storage position of the bidet. Reversing the position of the screw-top and engaging the top of the reservoir so that the larger portion of the hollow tube extends outwards from the reservoir define an operative position of the portable bidet, in which the bidet may be utilized in accordance with the intended use.

In accordance with a further aspect of the invention, the larger portion of the hollow tube has the tip provided with a discharge nozzle that can be adjusted from mist to spray to stream as desired by the user. Once filled with lukewarm water and closed with the screw-top, the inventive portable bidet is held by the user, conveniently positioned above the toilet seat, with the larger portion of the tube under the front of the user. Of course, the user may alternatively fill invention bidet with water or other fluid of any desired temperature, which can be done in a discrete fashion, and the filling can be performed outside of the toilet, which is particularly useful when the fluid contains medication for topical application.

Upon applying an external squeezing force to the reservoir, the water is pushed down the tube, and out of the pre-set nozzle, thus cleansing the desired body part of the user.

According to still a further aspect of the invention, the reservoir can alternatively be provided with a check valve allowing rapid expansion of the reservoir after a portion of water has been discharged. As a result, the inventive bidet provides a time-efficient cleansing process.

The inventive bidet is thus advantageous in many respects including, but not limited, to provide a portable convertible structure that is easy to use and store. The inventive bidet is portable, thereby allowing the user to carry the invention wherever desired and discretely perform a non-abrasive cleansing function regardless of configuration of the available toilet or sanitary facilities.

The inventive bidet provides a safe, efficient and sanitary warm, or other desired temperature, water delivery system, provides an adjustable safe nozzle head for both external and internal treatments, and provides a simple, cost-efficient and easily maintained structure; allowing the user to conveniently cleanse themselves in a non-obtrusive manner.

### BRIEF DESCRIPTION OF THE DRAWINGS

The above and other objects, features and advantages will become more readily apparent from the detailed description of the invention accompanied by the following drawings, in which:

FIG. 1 is a front view of the inventive portable bidet in a packaged or storing position;

FIG. 2 is an exploded view of the inventive portable bidet of FIG. 1;

FIG. 3 is a side view of the inventive portable bide in an operative ready-to-use position; and

FIG. 4 is a view of an alternative embodiment of a fluid-delivering unit having a telescopically configured tube.

### DETAILED DESCRIPTION OF THE PREFERRED EMBODIMENTS

In the drawings, the same or similar elements are denoted by the same reference numerals. In the following description, a detailed description of known functions and configurations incorporated herein will be omitted when it may obscure the subject matter of the present invention with unnecessary detail.

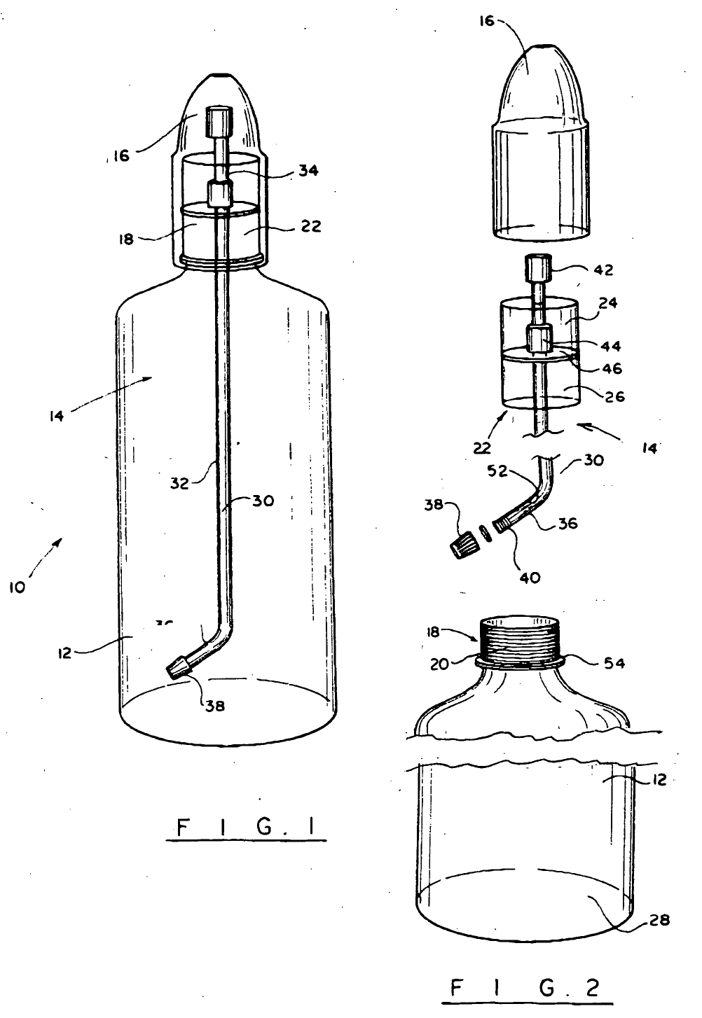

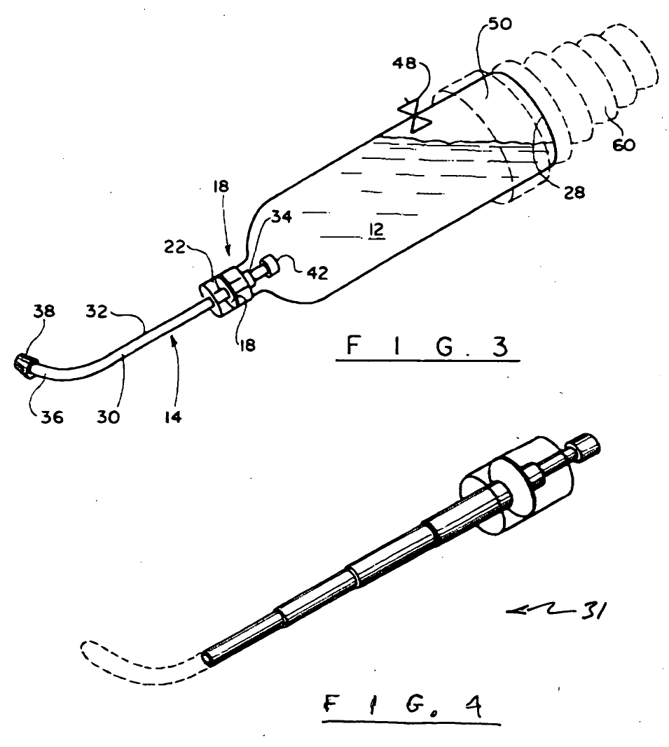

The inventive portable bidet 10 illustrated in FIGS. 1-4 includes a convertible structure allowing the user to minimize the bidet's overall size while the latter is stored, as shown in FIG. 1, and converting to an operative position, as shown in FIG. 3.

Essentially, the portable bidet 10 includes a reservoir 12 preferably, but not necessarily, having a size and shape of a regular bottle, a fluid-delivering unit 14 removably attachable to the reservoir 12 and a lid 16 (FIGS. 1, 2) covering the bidet in its storing position, illustrated in FIG. 1. Convertibility of the bidet 10 is realized by displacing the fluid-delivering assembly 14 relative to the reservoir 12. Thus, in the storing position (FIG. 1), the fluid-delivering system 14 is coupled to the reservoir 12 so that a distal end thereof extends at a relatively small distance from the reservoir's top 18, whereas in the operative ready-to-use position (FIG. 3), a distal end thereof the fluid-delivering unit 14 projects at a relatively large distance.

The reservoir 12 is preferably molded from rubber or a reinforced plastic material, however, it can be formed of a thin metal or other material compatible for use as a bidet and capable of resiliently yielding to an external squeezing force. Regardless of the shape of the reservoir 12, its top 18 is preferably provided with outside screw-on threads 20 (FIG. 2) for engaging an inside screw-on threads of a plug 22 of the fluid-delivering unit 14. The plug 22 is formed with two oppositely directed thread arrangements formed on its opposite ends 24, 26 (FIG. 2), which are preferably uniformly dimensioned so that regardless of the position of the portable bidet 10, the distance between the plug 22 and a bottom 28 of the reservoir 12 remains unchanged.

Alternatively to a threaded connection, the plug 22 can be press-fit upon the reservoir's top 18. Note that while the reservoir's top 18 is disclosed with the external thread and the plug 22 with the internal thread, the inventive bidet 10 can be equally operative with a thread formed on outer side of the plug 22 and the inner surface of the top 18. Insignificant dimensional modifications allowing the plug 22 to engage the inner surface of the reservoir's top 18 can readily accomplish it.

In addition to the plug 22, the fluid-delivering unit 14 includes a hollow tube 30 (FIGS. 1-3) traversing the plug 22 and fixed thereto so as to have its larger portion 32 (FIGS. 1, 3) project beyond the reservoir 12 when in the operative position of the bidet 10. The larger portion 32 of the tube 30 is configured with an end area functioning a discharge end 36 (FIGS. 1, 2), which preferably is angled to facilitate delivery of the fluid from the reservoir 12 onto the desired body part. Mounted on the end area 36 of the tube 30 is a nozzle 38 (FIGS. 1-3) which can be configured to adjust fluid flow from mist to spray to stream, to meet individual preferences. Preferably, the nozzle 38 is formed with an inner thread engaging an outer thread 40 (FIG. 2) of the tube's end area 36. The smaller portion 34 of the tube 30 has respective end area preferably formed with a multi-hole tip 42 (FIGS. 2, 3) configured with an outer diameter larger than the diameter of the rest of the tube 30 except for a flanged part 44 (FIG. 2). The latter is fixed to an O-ring 46 (FIG. 2) sealingly dividing the plug 22 into the threaded opposite ends 24 and 26.

The fluid-delivering unit 14 can be modified so as to have the tube 30 constructed of several components 31 sealingly displaceable relative to one another in a telescopic manner, as shown in FIG. 4. In accordance with this modification, the user does not have to detach the plug 22 to set the portable bidet 10 in one of the operative and storage positions. Any of these positions can be obtained by displacing the end area with the multi-hole tip 42 (FIGS. 2, 4) into or out of the hollow tube 30, thereby allowing the tube to either extend to the operative position or collapse in the storage position. The tube 30 may be made from shape-memory/material configured so that upon releasing an end component 46 (FIG. 4) of the tube 30, it will assume an angled position relative to the rest of the tube 30. In addition, to further increase the fluid velocity through the discharge end area 36 (FIG. 2), the tube 30 may be provided with a reduced diameter portion 52 operating as a venturi valve producing a low-pressure zone at that reduced diameter.

To provide a rapid pumping action, if necessary, the reservoir 12 may be provided with an aperture in its sidewall 50 (FIG. 3) shaped and sized to receive a check valve 48 allowing air to flow into the reservoir 12 after it has been constricted by the user. As a consequence, the reservoir 12 is readily restored to its original expanded state, as shown in FIGS. 1-3.

The removable lid 16 (FIG. 2) covers the inventive portable bidet 10 and is advantageously used during the storage or transportation of the bidet. Preferably, the lid 16 is snapped on a rim 54 of the reservoir 12. Alternatively, however, the plug 22 may be provided with an external screw engaging an inner thread provided on the lid 16.

In a preferred mode of operation, the portable bidet 10 is operated by initially removing the lid 16, unscrewing the fluid-delivering unit 14 from the reservoir 12, which is then rinsed out. Subsequently, the reservoir is filled with water of a desired temperature, and the fluid-delivering unit 14 is screwed so that the larger portion 32 of the tube 30 projects from the reservoir 12. Alternatively, the portable bidet 10 can be filled with liquid and then stored on a shelf, allowing the liquid to achieve room temperature. Such alternative is particularly useful when the fluid is a medicated fluid.

Cleansing the desired body part can be fulfilled by periodically pumping the reservoir 12. Alternatively, as diagrammatically shown in FIG. 3, the reservoir 12 may be hermetically coupled to a pump 60 formed either integrally with the reservoir or detachable therefrom and formed of material which is more flexible than material of the reservoir. The inventive portable bidet 10 may be packaged as a kit including all of the parts disclosed hereinabove. Although the inventive assembly has been disclosed as a bidet, its use is not limited exclusively to cleansing the rectal area and can be easily expanded to cleansing any body part, thereby functioning as a hand held shower-type washer.

Although the preferred embodiments of the present invention have been disclosed for illustrative purposes, those skilled in the art will appreciate that various modifications of the shape and dimensions of the disclosed structure as well obvious additions and substitutions are possible, without departing from the scope and spirit of the invention as disclosed in the accompanying claims.

1. A portable bidet comprising a reservoir refillable with fluid and a fluid-delivering unit selectively engaging the reservoir in a storing position, in which a larger portion of the fluid-delivering unit is housed within the reservoir, and in an operative position, in which the fluid-delivering unit extends outwards from the reservoir at a distance larger than a distance at which the fluid-delivering distance extends in the storing position.

2. The portable bidet of claim 1, wherein the fluid-delivering unit is configured with a plug removably engaging a top of the reservoir in the operative and storing positions, and a hollow tube extending through the plug and provided with a larger portion and a smaller portion, a length of which is smaller than a length of the larger portion.

3. The portable bidet of claim 2, wherein the plug has opposite inner and outer sides, one of the inner and outer sides being divided into oppositely extending end regions each provided with a respective thread directed oppositely to a thread formed on the other end region to provide engagement between the top of the reservoir and the plug in the operative and storing positions.

4. The portable bidet of claim 3, wherein the fluid-delivering unit further has a seal element sealingly mounted to the inner side of the plug substantially midway an entire length of the plug and dividing the plug into the end regions.

5. The portable bidet of claim 2, wherein the larger and smaller portions of the tube each have a respective end area, wherein the end area of the smaller portion is immersed into fluid filling the reservoir in the operative position and provided with a multiplicity of holes traversed by the fluid in response to a squeezing force upon the reservoir.

6. The portable bidet of claim 5, further comprising a nozzle removably mountable to the end area of the larger portion of the tube and configured to adjust fluid flow from mist to spray to stream.

7. The portable bidet of claim 6, wherein the end area of the larger portion of the tube is angled with respect to a stretch of the tube connecting the opposite end areas of the larger and smaller portions of the tube.

8. The portable bidet of claim 2, wherein the plug is shaped and dimensioned to press-fit the top of the reservoir.

9. The portable bidet of claim 1, further comprising a lid removably closing a top of the reservoir and covering the fluid-delivering unit in the storage position.

10. A portable bidet for cleansing an external surface of a user, comprising:
a reservoir refillable with fluid; and
a fluid-delivering unit removably coupled to and displaceable relative to the reservoir, wherein a larger portion of the fluid-delivering unit is housed within the reservoir when a storing position and the larger portion of the fluid-delivering unit extends outwards from the reservoir when in an operative position.

11. The portable bidet of claim 10, wherein the fluid-delivering unit includes a plug hermetically coupled to the reservoir to prevent an undesirable fluid leak, and a tube guiding the fluid from the reservoir to a desired body part in the operative position.

12. The portable bidet of claim 11, wherein the hollow pipe includes a plurality of components telescopically displaceable relative to one another to define the operative and storage positions.

13. The portable bidet of claim 11, wherein the plug has opposite ends each formed with an inside thread, the tube having a fixed length and being displaceable with the plug upon removing the plug from the reservoir to change the operative position to the storing position and conversely.

14. The portable bidet of claim 11, wherein the plug has an interior provided with opposite ends and a sealing element sealingly mounted to and dividing the interior of the plug into the opposite ends.

15. The portable bidet of claim 13, wherein the inner threads of the opposite ends formed on the opposite ends of the plug are directed oppositely to one another to provide coupling between the plug and the top of the reservoir in the operative and storing positions.

16. The portable bidet of claim 10, further comprising a check valve mounted to a sidewall of the reservoir and operative to guide airflow into the reservoir upon ceasing an external force applied to the reservoir in the operative position to expand the reservoir to an unconstricted state.

17. The portable bidet of claim 10, further comprising a pump made of material more flexible than material of the reservoir and hermetically attached to a bottom of the reservoir.

18. The portable bidet of claim 17, wherein the material of the reservoir is selected from reinforced plastic, rubber or metal.

19. The portable bidet of claim 11, further comprising a nozzle removably coupled to the larger portion of the tube and operative to adjust fluid flow from mist to spray to stream in the operative position of the fluid-delivering unit.

20. The portable bidet of claim 10, further comprising a lid removably attachable to a top of the reservoir and covering the fluid-delivering unit in the storing position thereof.
